(19) United States
(12) Patent Application Publication
(10) Pub. No.: US 2009/0180590 A1
(43) Pub. Date: Jul. 16, 2009

(54) X-RAY IMAGE APPARATUS AND METHOD OF IMAGING AN OBJECT UNDER EXAMINATION

(75) Inventors: Ludger Borgmann, Beelen (DE); Jürgen Wiechers, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/305,979

(22) PCT Filed: Jun. 13, 2007
(86) PCT No.: PCT/IB2007/052241

§ 371 Date: Dec. 22, 2008

(30) Foreign Application Priority Data
Jun. 22, 2006 (EP) 06115862.2

(51) Int. Cl. H05G 1/42

(52) U.S. Cl. 378/97

(57) ABSTRACT

An X-ray image apparatus (100) for imaging an object under examination (101), the X-ray image apparatus (100) comprising an X-ray source (103) adapted for generating an X-ray beam (104) to be directed to the object under examination (101), a dose measuring device (106) for measuring an X-ray dose of the X-ray beam (104) in at least one selected (110, 112) of a plurality of measurement fields (108 to 114) after transmission of the X-ray beam (104) through the object under examination (102), and an illumination device (115) for illuminating a surface portion (117) of the object under examination (101) which surface portion (117) is indicative of the at least one selected (110, 112) of the plurality of measurement fields (108 to 114).

### FIELD OF THE INVENTION

The invention relates to an X-ray image apparatus.

Moreover, the invention relates to a method of imaging an object under examination.

Beyond this, the invention relates to a program element.

Furthermore, the invention relates to a computer-readable medium.

### BACKGROUND OF THE INVENTION

X-ray imaging is important in many technical fields including medical applications.

Medical imaging is the process by which physicians evaluate an area of the subject's body that is not externally visible. Medical imaging may be clinically motivated, seeking to diagnose and examine disease in specific human patients. Alternatively, it may be used by researchers in order to understand processes in living organisms. Many of the techniques developed for medical imaging also have scientific and industrial applications.

In the case of radiography, the probe is an X-ray beam which is absorbed at different rates in different tissue types such as bone, muscle and fat. After having propagated through the body of the object under examination, the transmitted X-ray beam generates an intensity pattern being indicative of the internal structure of the object under examination.

GB 2,302,492 A discloses an X-ray system comprising a source and image amplifier. Two lasers with linear beams are located on the beam source, displaced by a 90° circumferential angle, such that they generate an aiming cross on the skin of the patient.

DE 299 06 438 U1 discloses a combined X-ray transmission and laser projection device. Integrated laser projectors are provided for a superficial illustration of X-rayed structures.

Thus, conventional systems may allow to indicate a portion on the skin of a patient which shall be irradiated with X-rays.

However, it may be still difficult for a human operator of the system to control whether manually adjusted irradiation parameters are appropriate.

### OBJECT AND SUMMARY OF THE INVENTION

It is an object of the invention to provide a user-friendly X-ray apparatus.

In order to achieve the object defined above, an X-ray image apparatus, a method of imaging an object under examination, a program element, and a computer-readable medium according to the independent claims are provided.

According to an exemplary embodiment of the invention, an X-ray image apparatus for imaging an object under examination is provided, the X-ray image apparatus comprising an X-ray source adapted for generating an X-ray beam to be directed to the object under examination, a dose measuring device for (spatially dependently) measuring an X-ray dose of the X-ray beam in at least one (or more) selected of a plurality of measurement fields after transmission of the X-ray beam through the object under examination, and an illumination device for illuminating a surface portion of the object under examination which surface portion is indicative of the at least one selected of the plurality of measurement fields.

According to another exemplary embodiment of the invention, a method of imaging an object under examination is provided, the method comprising directing an X-ray beam to the object under examination, spatially dependently measuring an X-ray dose of the X-ray beam in at least one selected of a plurality of measurement fields after transmission of the X-ray beam through the object under examination, and illuminating (before and/or during irradiating the object under examination with X-rays) a surface portion of the object under examination which surface portion is indicative of the at least one selected of the plurality of measurement fields.

According to yet another exemplary embodiment of the invention, a computer-readable medium is provided, in which a computer program of imaging an object under examination is stored which, when being executed by a processor, is adapted to control or carry out a method having the above mentioned features.

According to still another exemplary embodiment of the invention, a program element of imaging an object under examination is provided, which program element, when being executed by a processor, is adapted to control or carry out a method having the above mentioned features.

Data processing for process control and data evaluation purposes which may be performed according to embodiments of the invention can be realized by a computer program, that is by software, or by using one or more special electronic optimization circuits, that is in hardware, or in hybrid form, that is by means of software components and hardware components.

According to an exemplary embodiment of the invention, an X-ray image apparatus (for instance for radiography applications) may be provided for generating a visible image of an object under examination or of an internal region of interest of the object under examination (for instance a lung portion of a human patient or a suspicious portion within a baggage item under examination). An X-ray source (that is to say an X-ray tube or the like) may be provided for generating electromagnetic radiation in the X-ray wavelength range. This X-ray beam may be collimated using a collimator so as to define a portion of the object under examination to be irradiated with the X-radiation, and then this beam is transmitted through the object to be detectable, after propagation through the object, by a detector. Such a detector may be a cassette (so-called film foil technology) or may be a digital X-ray detector device (for instance a scintillation detector with a connected photodiode array, or a CCD).

Between the detector and the object under examination, a dose measuring device (for instance an ionisation chamber called amplimat chamber inside PMS) may be positioned which may be an arrangement of a plurality of measurement fields (for instance five measurement fields). A human operator may now, before starting the irradiation with X-rays, select some (or all) of the measurement fields. Only this selected group of measurement fields will then be used—during a subsequent irradiation of the object under examination with X-rays—for measuring a radiation dosage during the actual irradiation with X-rays. When a predetermined threshold value of the radiation dosage measured only in the selected or activated measurement fields has been exceeded, a trigger signal may be generated for switching off the X-ray tube.

The decision which of the measurement fields shall be used for this dose measuring may be based on the characteristics of the object under investigation. For instance, if a lung shall be imaged by radiography, three of five of the measurement fields may be activated in correspondence with a geometrical position of the lung relative to the X-ray apparatus and in dependence of X-ray absorption characteristics of lung material.

However, it may be difficult for a human operator to choose appropriate measurement fields and ensure simultaneously that the geometrical arrangement of the measurement fields (which are usually located behind the patient, along the propagation path of the X-ray beam) and the position of the patient as well as the position of the X-ray tube are in proper accordance to one another.

The illumination device may map or image one or more measurement fields positioned behind an object under examination in a correct positional arrangement, in the correct size and in the correct shape onto a (front) surface portion of the object. This projection may be performed two-dimensionally (alternatively one-dimensionally, i.e. as lines, or zero-dimensionally, i.e. as points).

According to an exemplary embodiment of the invention, in order to enable a better control of the selection of the measurement fields for a human operator, an illumination device may be provided for illuminating a portion of the skin of the patient to indicate (preferably at a side of the patient's body which is directed towards or faces the X-ray tube and is not directed towards the dose measuring device) which portions of the human body correspond to the actual selection of the active measurement field(s) and will thus be used for dose measuring for measuring a target dose which, when reached, triggers termination of the irradiation of the object under examination by the X-radiation.

By projecting a light pattern on the skin of the patient illustrating portions of the body which geometrically relate to measurement fields intended to be used for dose measuring may simplify operation of the device significantly, may ensure to keep exposure of the patient with X-rays small, and may improve accuracy of the captured image, since overexposure and underexposure of the object under examination with X-rays may be securely prevented, thereby ensuring a meaningful image of the region of interest within the object under examination.

An X-ray tube may, for instance, be attached to, mounted on or installed at a wall or a ceiling with a corresponding fastening element. Via a user interface, a human operator (for instance a physician or technical stuff) may select the measurement fields of the dose measuring device, may select a collimator-defined range of exposure of the patient with X-rays, and may adjust further parameters indicative of a specific radiography examination (for instance a kind of tissue to be irradiated, characteristics of a patient like age, etc.).

The dose measuring device which may be located between the patient and the detector may measure the dose only in the selected area and may initiate switching off the X-ray tube when a desired dose is measured. This dose may be selected so that the X-rays measurable by a detector located behind the dose measuring device may capture the image without overexposure and underexposure. Thus, according to one exemplary scenario, the whole cross section of a patient will be irradiated with X-rays, but only a subportion of this irradiated portion will be used for measuring dose.

In contrast to conventional systems, in which the measurement fields behind the patient are not visible for a human operator, it is possible according to embodiments of the invention, based on the optically highlighted portions indicated by the illumination device on the patient's body, to arrange the patient in such a manner that her or his orientation is correct with regard to the measurement fields.

Thus, the measurement fields may be visually superimposed on the patient's skin. For this purpose, a laser or any other suitable illumination device (like a halogen lamp, LEDs, etc.) may be provided, preferably in the vicinity of the collimators of the X-ray tube to indicate the present selection of measurement fields. Thus, when an operator changes the adjustment of active and passive measurement fields, this will have an impact on the portions highlighted on the skin of the patient's body using the illumination device. Such a feature may aid a human operator in adjusting the measurement fields correctly.

The dose measuring device which may also be denoted as an amplimat chamber may switch off the radiation and may therefore ensure a correct dose in order to image a particular organ without overexposure and underexposure. A laser projection unit may indicate in which portions the dose will be measured during the later actual X-ray measurement, so as to allow for an intuitive control whether a patient's orientation is correct or has to be corrected. Therefore, the selected amplimat items may be optically indicated. Therefore, it may be made clear for a human operator how the amplimat chamber is oriented relatively to the patient, which may be difficult in conventional systems, since the measurement chambers may be located behind the patient. The selection of measurement fields may be performed on the basis of expert knowledge and/or experience and/or empiric data.

Therefore, according to an exemplary embodiment, visual dose measuring field illustration on patient's body may be made possible. A laser scanner or a laser may be used for displaying the geometrical portions or images on the body of the patient to allow an illustration and the dynamic adjustment of previously manually adjusted system parameters (like the selection of amplimat fields). Such amplimat fields may be measurement fields for an automatic exposure system. The quantitatively correct illustration of the activated measurement fields may allow for a correct selection of the measurement fields and thus an improvement of the image quality with reduced patient dose.

Therefore, an X-ray system with a laser scanner may be provided which produces a virtual image of selected measurement fields of an amplimat chamber directly on the skin of a patient's body. The system may be used to optically display the collimated X-ray field on the patient's body.

Therefore, an X-ray system with an automatic exposure control for dose limitation may be provided. The correct selection of the used measurement fields in accordance with a specific imaging situation is an important aspect for the image quality and the radiation exposure for the patient. For this purpose, the position and size of the measurement fields may be projected directly onto the skin of the patient. When individual measurement fields are switched on or are switched off, this may have an influence on the portions highlighted on the skin of the patient. In other words, the illumination may be updated in real-time.

Thus, in different exposure situations, the individual measurement fields are optically indicated in a correct position on the body of the patient so as to allow to control, prior to the actual X-ray exposure, the correct selection of the measurement fields and their position with regard to the body regions to be irradiated.

This may be realized using a laser projection device projecting an image to the body of the patient which corresponds to the geometrical arrangement of the measurement field located behind the patient. The position of the selected measurement fields in relation to the patient may be known by evaluation of appropriate geometry parameters and may serve for the laser projection unit as an input device for calculating a correct picture of the measurement fields on the body of the patient. Simultaneously, the laser projection unit may serve to indicate the superimposed area of the radiation field on the body of the patient. Optionally, the laser projection unit may serve to indicate further exposure relevant parameters directly on the body of the patient or on a table plate which may be positioned laterally of the patient.

Taking such measures may allow for a faster operation due to a simplified operability, since no time consuming measurement field controls have to be performed. Furthermore, erroneous exposures may be prevented which may conventionally occur due to an incorrect measurement field selection. Moreover, erroneous exposures due to inaccurate measurement position adjustments may be avoided. The laser scanner may have a long lifetime and a high precision. Beyond this, a laser scanner may allow for a properly defined and high definition imaging of an edge portion of the highlighted irradiation field.

The medical application of X-ray systems may include the examination of human beings, but also of animals so that embodiments of the invention may be employed in the veterinary field.

Next, further exemplary embodiments of the X-ray image apparatus will be described. However, these embodiments also apply for the method, for the program element and for the computer-readable medium.

The X-ray image apparatus may comprise a detection device for detecting the X-ray beam after transmission through the object under examination. Thus, the geometrical path of the X-ray beams emitted by the X-ray tube is such that the X-rays first pass a collimator for defining a portion of the human body which is illuminated. After that, the X-rays pass the body of the human being and are selectively damped in dependence of the local material so as to generate a light-dark pattern. After having transmitted the patient, the damped X-rays pass a dose measuring device for measuring the dose of the transmitted X-rays. After that, the X-rays are detected by the detector. The detection device may be a conventional film plate or may also be a digital X-ray detector.

A determining unit may be provided for determining structural information concerning the object under examination based on the detected X-ray beam. For instance, in the case of a digital detector, the detected pattern may be post-processed to improve the accuracy of the image. This may be performed with a determining unit which may be realized as a microprocessor or the like.

The X-ray image apparatus may comprise an X-ray beam control unit for switching off the X-ray beam when the measured X-ray dose of the X-ray beam in the at least one selected of the plurality of measurement fields reaches a predetermined dose threshold value. Thus, the dose of the selected measuring fields of the dose measuring device may be added, and when the sum is larger than a threshold value, this may be indicative of a sufficient amount of X-rays needed for proper image quality. In such an event, the X-ray beam is switched off to avoid both overexposure (due to a too high dose) and underexposure (due to a too low dose).

The X-ray image apparatus may comprise a user interface for enabling a user to select at least one of the group consisting of the at least one selected of the plurality of measurement fields, the object under examination, and the predetermined dose threshold value. Such a user interface may be, for instance, a graphical user interface (GUI). This may include a display unit like an LCD device, a cathode ray tube, a plasma device, etc. Furthermore, such a user interface may include input elements like a keypad, buttons, a joystick, a trackball or even a microphone of a voice recognition system.

The illumination device may comprise an optical light source, that is to say may be capable to generate one or more beams of optical light, particularly in the range between essentially 400 nm and essentially 800 nm. Thus, the structures being projected onto a patient's body may be visible for the human eye.

The illumination device may comprise a laser projector. With a laser projector, it is possible to generate the images on the skin of the patient with high accuracy and intensity. Such images may be highlighted areas or lines defining an area indicative of a corresponding measurement field.

The illumination device may further be adapted for illuminating a surface portion of the object under examination which surface portion faces the X-ray source. Therefore, the body portion of the patient may be illuminated which is located opposite to the detector and which is directed towards the illumination device. This is a proper position for a physician or a technical staff to control the correct selection of the measurement fields on the human body, due to a common geometry of an X-ray image apparatus.

The illumination device may be adapted for illuminating the surface portion of the object under examination prior to exposing the object under examination to the X-ray beam. Therefore, the correct selection of the measurement fields may be performed before the patient has been exposed with X-ray radiation, so as to prevent unnecessary harmful irradiation of the human body.

The illumination device may be positioned adjacent a collimator of the X-ray source. Such a collimator may collimate an X-ray beam generated by an X-ray tube so as to define a portion of the human body which is actually irradiated by the radiation. Locating the illumination device and the collimator spatially close to one another, a compact system may be provided which further minimizes or reduces any possible optical image distortions or aberration, due to the relative geometrical configuration of the individual components with respect to one another.

The illumination device may be integrated in a casing accommodating the X-ray source. In other words, X-ray source and illumination device may be located in a common housing which may allow for a compact realisation of the system and may keep optical image distortions small.

The X-ray image apparatus may be adapted to be mountable on at least one of the group consisting of a wall, a ceiling, and a floor. Therefore, the X-ray image apparatus may have relatively fixed geometrical positioning which allows to monitor a physician the present illumination conditions in an appropriate manner.

The X-ray image apparatus may also be adapted as a portable X-ray image apparatus. In a portable X-ray image apparatus, the correct positioning is particularly difficult and important to avoid unnecessary irradiation of the patient.

The X-ray image apparatus may be configured as one of the group consisting of a baggage inspection apparatus, a medical application apparatus, a material testing apparatus and a material science analysis apparatus. Therefore, such a radiography or fluorescence based X-ray image apparatus may be used in many technical fields.

The illumination device may be adapted for illuminating a two dimensional surface portion (that is to say an area instead of only illuminating lines) of the object under examination which two dimensional surface portion is indicative of the at least one selected of the plurality of measurement fields. Such a 2D illumination may be performed advantageously using a laser scanner or the like.

The illumination device may be adapted for dynamically illuminating the surface portion of the object under examination which surface portion is indicative of the at least one selected of the plurality of measurement fields. In this context, the term “dynamic” may denote that the illumination may be time-dependent, so that a modified selection of measurement fields may result in a modified illumination.

In serial production, embodiments of the invention may be used for correctly positioning parts to be assembled (by gluing, soldering, etc.) with the “optical” help of the illumination device, and thereafter documenting the process using X-rays.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows an X-ray image apparatus according to an exemplary embodiment of the invention.

### DESCRIPTION OF EMBODIMENTS

The illustration in the drawing is schematically. In different drawings, similar or identical elements are provided with the same reference signs.

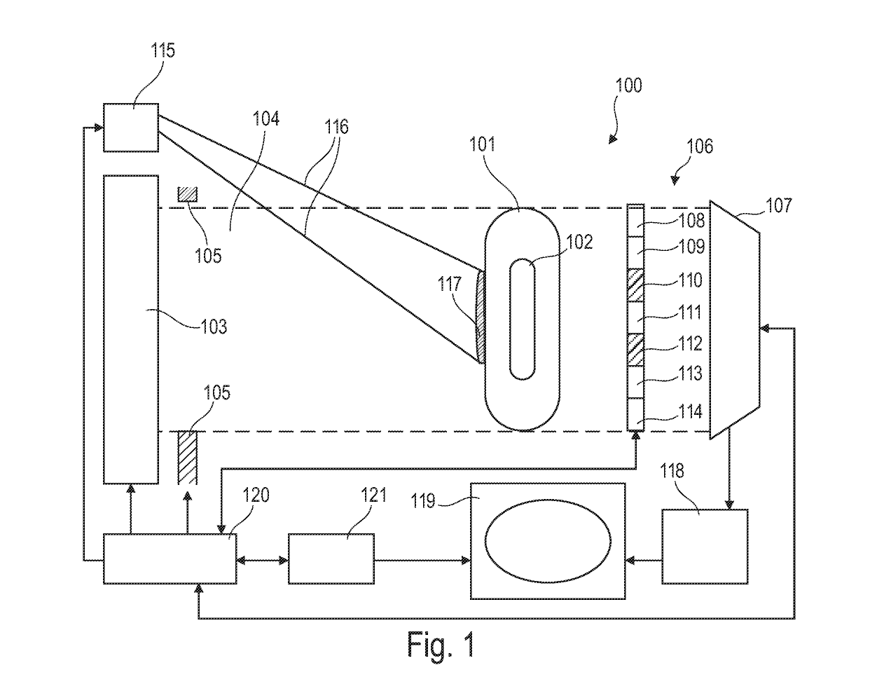

In the following, referring to FIG. 1, an X-ray image apparatus 100 according to an exemplary embodiment of the invention will be explained.

The X-ray image apparatus 100 is adapted for imaging a portion of a human body 101, in the described exemplary case, adapted to image a lung 102.

The X-ray image apparatus 100 comprises an X-ray source 103 (an X-ray tube) which is capable of generating an X-ray beam 104 to be directed to the human body 101, particularly including the lung portion 102. The actual width and geometry of the beam 104 may be defined with a collimator unit 105.

Furthermore, a dose measuring device 106 is provided and located between the human body 101 and a scintillation detector 107. The dose measuring device is adapted for spatially dependently measuring an X-ray dose of the X-ray beam 104 in at least one selected of a plurality of measurement fields after transmission of the X-ray beam 104 through the lung 102. In the described embodiment, the dose measuring device comprises seven measurement fields which are shown schematically in FIG. 1 and are indicated with reference numerals 108 to 114. In the present case, as visually indicated in FIG. 1, only the measurement fields 110 and 112 are selected, whereas the measurement fields 108, 109, 111, 113 and 114 are switched off.

For a lung acquisition, the sternum und the spinal column should be gated or masked for estimating the dose. The fields 110 and 112 are therefore of interest, alternatively the fields 109 and 113. As a consequence of the illustration of the fields 110, 112 on the skin, the operator can accept or adjust the selection. When illustrating the sternum and/or the spinal column, the measurement field 111 may be needed. By illustrating the measurement field(s) on the skin, the position of the radiation field can be corrected, if necessary.

In the industrial field, the field illustration on an object may have the consequence that the selection of the “correct field(s)” can be performed in an automatic manner, or the orientation/position of the object may be modified automatically, or both.

The selection of the selected dose measuring devices 110 and 112 may be performed by a human operator operating the system 100 in accordance with peculiarities of the object under examination 102, in the present case with the geometrical arrangement and the material properties of the lung portion 102.

Beyond this, a laser projection device 115 is provided which is capable of emitting one or more spatially adjustable or modifiable laser beams 116 so as to selectively illuminate a surface portion 117 of the human body 102 which surface position 117 is indicative of the selected ones of the plurality of measurement fields 108 to 114. Thus, a geometrical arrangement of the selected measurement fields 110 and 112 is mapped in the form of a pattern onto the skin of the patient by a light portion 117. With the light portion 117, a (two-dimensional) area of the skin may be highlighted.

The laser projection device 115 may be a laser scanner which may generate two-dimensional graphical illustrations, not necessarily a point-wise laser beam image. The two-dimensional projection onto the body of the patient using the laser scanner thus corresponds exactly—with regard to size and position—the (activation state of the) measurement fields positioned behind the patient. This may also allow for a variable size of an illuminated area of the measurement fields.

The detector 107 is adapted for detecting the X-ray beam 104 after transmission to the body 101 and after transmission through the dose measuring device 106.

Furthermore, a processing unit or determining unit 118 is foreseen which determines structural information concerning the lung 102 based on the detected X-ray beam. The output signal of the processing unit 118 may be supplied to a display 119 for displaying the image of the lung 102 on a screen. A central control unit 120 is foreseen (for instance a CPU, “central processing unit”) which controls the entire function of the apparatus 100. Particularly, the control unit 120 may be adapted for switching off the X-ray beam 104 by actuating the X-ray tube 103 when the measured X-ray tube dose of the X-ray beam 104 in the selected measurement fields 110 and 112 reaches a predetermined dose threshold value.

Beyond this, a user interface 121 is foreseen for enabling a human user to select the active measurement fields 110 and 112, to define the object under examination 102 (in the present case a lung), to define a predetermined dose threshold value, etc. Therefore, using expert knowledge, a human operator may set up the system 100 for a specific imaging application.

As can further be taken from FIG. 1, the laser projection device 115 illuminates a front portion of the human body 101, namely a skin portion which faces the X-ray source 103 and which is located opposite to the surface of the body 101 neighboured to the dose measuring device 106. By taking this measure, a proper portion of the human body 101 is illuminated which, in practical applications, is particularly suitable for being monitored by an operator of the system 100.

In the following, a typical procedure of using the X-ray apparatus 100 will be explained.

First, the human being 101 is positioned between the X-ray tube 103 and the dose measuring device 106. Then, the operator operates the user interface 121 in a manner to specify the measurement to be carried out, that is to say adjusting the various parameters. This particularly includes defining the active measurement fields 110 and 112 of the plurality of measurement fields 108 to 114 in correspondence with the specific measurement to be carried out, particularly in correspondence with the organ 102 to be investigated. This preselection is indicated on the skin of the body as an illuminated portion 117 generated by the laser projection device 115. After the operator has accepted a specific selection of the measurement fields 110 and 112, she or he may initiate generation of the X-ray beam 104 which will expose the human body 101 with X-rays 104. Only the X-rays impinging on the selected measurement fields 110 and 112 will be used for dose measuring, and when a specific dose value has been obtained, deactivation of the X-ray tube 103 will be triggered. The corresponding dose is selected to be sufficient to have an image on the detector 107 which is neither overexposed nor underexposed. A resulting image may then be displayed on the display 119.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. An X-ray image apparatus (100) for imaging an object under examination (101), the X-ray image apparatus (100) comprising
an X-ray source (103) adapted for generating an X-ray beam (104) to be directed to the object under examination (101);
a dose measuring device (106) for measuring an X-ray dose of the X-ray beam (104) in at least one selected (110, 112) of a plurality of measurement fields (108 to 114) after transmission of the X-ray beam (104) through the object under examination (102);
an illumination device (115) for illuminating a surface portion (117) of the object under examination (101) which surface portion (117) is indicative of the at least one selected (110, 112) of the plurality of measurement fields (108 to 114).

2. The X-ray image apparatus (100) according to claim 1,
comprising a detection device (107) for detecting the X-ray beam (104) after transmission through the object under examination (1101).

3. The X-ray image apparatus (100) according to claim 2,
comprising a determining unit (118) for determining structural information concerning the object under examination (101) based on the detected X-ray beam (104).

4. The X-ray image apparatus (100) according to claim 1,
comprising an X-ray beam control unit (120) for deactivating the X-ray source (103) when the measured X-ray dose of the X-ray beam (104) in the at least one selected (110, 112) of the plurality of measurement fields (108 to 114) exceeds a predetermined dose threshold value.

5. The X-ray image apparatus (100) according to claim 1,
comprising a user interface (121) for enabling a user to specify at least one of the group consisting of the at least one selected (110, 112) of the plurality of measurement fields (108 to 114), the object under examination (101), and the predetermined dose threshold value.

6. The X-ray image apparatus (100) according to claim 1,
wherein the illumination device (115) comprises a laser projector.

7. The X-ray image apparatus (100) according to claim 1,
wherein the illumination device (115) is adapted for illuminating the surface portion (117) of the object under examination (101) which surface portion (117) is directed towards the X-ray source (103).

8. The X-ray image apparatus (100) according to claim 1,
wherein the illumination device (115) comprises an optical light source.

9. The X-ray image apparatus (100) according to claim 1,
wherein the illumination device (115) is adapted for illuminating the surface portion (117) of the object under examination (101) prior to exposing the object under examination (101) to the X-ray beam (104).

10. The X-ray image apparatus (100) according to claim 1,
wherein the illumination device (115) is positioned adjacent a collimator (105) of the X-ray source (103) or is integrated in a casing accommodating the X-ray source (103).

11. The X-ray image apparatus (100) according to claim 1,
wherein at least a part of the X-ray image apparatus (100) is mountable on at least one of the group consisting of a wall, a ceiling, and a floor.

12. The X-ray image apparatus (100) according to claim 1,
adapted as a portable X-ray image apparatus.

13. The X-ray image apparatus (100) according to claim 1,
configured as one of the group consisting of a baggage inspection apparatus, a medical application apparatus, a material testing apparatus and a material science analysis apparatus.

14. The X-ray image apparatus (100) according to claim 1,
wherein the illumination device (115) is adapted for illuminating a two dimensional surface portion (117) of the object under examination (101) which two dimensional surface portion (117) is indicative of the at least one selected (110, 112) of the plurality of measurement fields (108 to 114).

15. The X-ray image apparatus (100) according to claim 1,
wherein the illumination device (115) is adapted for dynamically illuminating the surface portion (117) of the object under examination (101) which surface portion (117) is indicative of the at least one selected (110, 112) of the plurality of measurement fields (108 to 114).

16. A method of imaging an object under examination (101), the method comprising
directing an X-ray beam (104) to the object under examination (101);
measuring an X-ray dose of the X-ray beam (104) in at least one selected (110, 112) of a plurality of measurement fields (108 to 114) after transmission of the X-ray beam (104) through the object under examination (101);
illuminating a surface portion (117) of the object under examination (101) which surface portion (117) is indicative of the at least one selected (110, 112) of the plurality of measurement fields (108 to 114).

17. A computer-readable medium, in which a computer program of imaging an object under examination (101) is stored which, when being executed by a processor (120), is adapted to control or carry out a method of claim 16.

18. A program element of imaging an object under examination (101), which program element, when being executed by a processor (120), is adapted to control or carry out a method of claim 16.
